(19) United States
(12) Patent Application Publication
(10) Pub. No.: US 2018/0309702 A1
(43) Pub. Date: Oct. 25, 2018

(54) METHOD AND DEVICE FOR PROCESSING DATA AFTER RESTART OF NODE

(71) Applicant: Alibaba Group Holding Limited, Grand Cayman (KY)

(72) Inventors: Zhuoling Li, Zhejiang (CN); Qi Xiong, Zhejiang (CN); Sen Han, Zhejiang (CN); Julei Li, Zhejiang (CN)

(73) Assignee: Alibaba Group Holding Limited

(21) Appl. No.: 16/016,435

(22) Filed: Jun. 22, 2018

Related U.S. Application Data
(63) Continuation of application No. PCT/CN2016/109953, filed on Dec. 14, 2016.

(30) Foreign Application Priority Data
Dec. 23, 2015 (CN) 201510977774.4

(51) Int. Cl. H04L 12/58; H04L 12/26; H04L 29/08

(52) U.S. Cl. CPC H04L 51/04; H04L 43/04; H04L 67/1008; H04L 67/1097; H04L 67/2842

(57) ABSTRACT

A method for processing data after a restart of a node comprises: acquiring, by a processing node, a time point of current legacy data with the longest caching time in a distributed message queue after a restart of the processing node has completed; determining a recovery cycle according to a current time point and the time point of the legacy data; and processing the legacy data and newly added data in the distributed message queue within the recovery cycle. Thus, an interruption of data processing resulting from a restart may be avoided, an impact on the user's feeling may be eliminated, and user experience is improved.

### CROSS REFERENCE TO RELATED PATENT APPLICATIONS

This application claims priority to and is a continuation of PCT Patent Application No. PCT/CN2016/109953, filed on 14 Dec. 2016, which claims priority to Chinese Patent Application No. 201510977774.4 filed on 23 Dec. 2015 and entitled “METHOD AND DEVICE FOR PROCESSING DATA AFTER RESTART OF NODE”, which are incorporated herein by reference in their entirety.

### TECHNICAL FIELD

The present disclosure relates to the field of communication technologies, and, more particularly, to methods for processing data after a restart of a node. The present disclosure also provide data processing devices.

### BACKGROUND

With the continuous development of Internet technologies, cloud computing platforms, also referred to as cloud platforms, have gained more and more attention. Cloud platforms may be classified into three categories according to functions: storage cloud platforms mainly for data storage, computing cloud platforms mainly for data processing, and comprehensive cloud computing platforms for both computing and data storage processing. A cloud platform allows a developer to either run a written program in the cloud, or use a service provided in the cloud, or both.

FIG. 1 is a schematic diagram of an architectural design of a real-time monitoring service of a cloud platform according to conventional techniques. The architectural design of a cloud platform log service is usually divided into five layers: a (log) collection layer, a (log) transport layer, a processing layer, a storage layer, and a monitoring center. The collection layer is responsible for reading users' various logs, and then sending the logs that need to be stored to the transport layer. In the schematic architectural diagram of the log service of the cloud platform according to conventional techniques shown in FIG. 1, the function of the layer is implemented by various agents in combination with existing cloud service functions. The agents are deployed on physical machines or virtual machines at all levels to read the users' logs by rule and send the logs. The processing layer is generally composed of multiple scalable worker nodes, and is responsible for receiving the logs from the transport layer, processing the logs and storing the logs into various storage devices. A processing worker is essentially a system process, which is stateless and may be scaled horizontally. Whether the order of logs may be ensured is closely related to the logic of the processing layer. The storage layer is responsible for data storage, and may be a physical disk, or a virtual disk provided by a distributed file system. The transport layer is located between the collection layer and the processing layer, and is responsible for ensuring that the logs are sent to the processing layer. The transport layer is generally implemented by message queues that provide redundancy and may be implemented with heaps, and serves as a bridge between the collection layer and the processing layer. The storage layer is responsible for data storage. The monitoring center includes an access layer. The access layer is provided with a dedicated access API, for providing unified data access interfaces externally.

The real-time monitoring service has a higher requirement on the real-time performance, and generally, requires the monitoring delay to be less than 5 minutes, one piece of monitoring data per minute. Under such a high real-time requirement, how to prevent data loss and duplication (at least to ensure that the monitoring curve is not too shaky and does not have any lost points) as much as possible during a system restart is a technical problem. The most critical issue is a restart policy of a stateful node, that is, the restart of a processing node in a real-time computing system.

In order to avoid the jitter problem of the monitoring curve caused by node restart, the conventional techniques mainly adopt the following three methods:

(1) Data Replay

This method replays the data in the first few minutes of the message queue during the restart, ensuring that the data is not lost.

(2) Persistent Intermediate State

This method periodically saves a statistics state to a persistent database and restores to the state during the restart.

(3) Simultaneous Processing of Two Pieces of Data

This method runs two real-time computing tasks at the same time according to the characteristic that the message queue supports multiple consumers. When one real-time computing task is restarted, data of the other real-time computing task is used, and then the method switches back to the restarted computing task after the restart.

However, the conventional techniques have the following disadvantages.

(1) Data replay easily leads to data duplication and depends on a message queue. Data processing often involves multiple data storage procedures, for example, it needs to update mysql metadata and store raw data to hadoop. In this case, data replay is likely to result in duplication of some of the stored data. Moreover, data replay depends on the replay function of the message queue, such as Kafka, while ONS does not support that.

(2) The persistent intermediate state is not suitable for scaling and upgrade, and is logically complex. Under many circumstances, a system restart is implemented for scaling or system upgrade, and the data that each processing node is responsible for will change after scaling, and becomes inconsistent with the original intermediate state. An upgrade may also result in an inconsistency between the intermediate states. Moreover, the logic of persistence and recovery is relatively complex when computing is complex, with many intermediate states.

(3) Processing two pieces of data at the same time has excessive costs and requires more computing resources and storage resources. A larger amount of data processed will cause a greater waste.

It is thus clear that how to avoid, as much as possible, the lagging problem of data processing caused by a node restart while reducing the consumption of hardware resources is an urgent technical problem to be solved by those skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method for processing data after a restart of a node, to avoid the lagging problem of data processing caused by a node restart while reducing the costs for hardware modification. The method is applied to a data processing system that includes a distributed message queue and a processing node, and includes the following steps:

acquiring, by the processing node, a time point of current legacy data with the longest caching time in the distributed message queue after a restart of the processing node has completed;

determining, by the processing node, a recovery cycle according to a current time point and the time point of the legacy data; and

processing, by the processing node, the legacy data and newly added data in the distributed message queue within the recovery cycle.

For example, the data processing system further includes a storage node, and before the restart of the processing node has completed, the method further includes:

receiving, by the processing node, an instruction of closing a computing task; and

stopping, by the processing node, receiving data from the distributed message queue, and writing data currently cached in the processing node into the storage node upon completion of the processing of the data.

For example, the step of determining, by the processing node, a recovery cycle according to a current time point and the time point of the legacy data includes:

acquiring a time length from the time point corresponding to the legacy data with the longest caching time to the current time point; and

generating the recovery cycle having a time length consistent with the time length.

For example, the step of processing, by the processing node, the legacy data and newly added data in the distributed message queue within the recovery cycle includes:

setting multiple processing time periods sequentially according to the unit time length of the recovery cycle, and allocating to-be-processed data to each of the processing time periods based on the legacy data and the newly added data; and

processing the corresponding to-be-processed data within each of the processing time periods, and recovering the computing task to normal processing logic after the recovery cycle ends.

For example, the processing time period is composed of data processing time and data synchronization time in sequence, and the step of processing the corresponding to-be-processed data within each of the processing time periods includes:

processing the to-be-processed data within the data processing time, and storing the to-be-processed data that has been processed after the data processing time ends; and

discarding the to-be-processed data that has not been processed within the data synchronization time if the to-be-processed data that has not been processed exists after the data processing time ends.

Correspondingly, the present disclosure further provides a data processing device, applied as a processing node to a data processing system that includes a distributed message queue and the processing node. The data processing device includes:

an acquisition module configured to acquire a time point of current legacy data with the longest caching time in the distributed message queue after a restart has completed;

a determination module configured to determine a recovery cycle according to a current time point and the time point of the legacy data; and

a processing module configured to process the legacy data and newly added data in the distributed message queue within the recovery cycle.

For example, the data processing system further includes a storage node, and the data processing device further includes:

a closing module configured to receive an instruction of closing a computing task, stop receiving data from the distributed message queue, and write data currently cached in the data processing device into the storage node upon completion of the processing of the data.

For example, the determination module includes:

an acquisition submodule configured to acquire a time length from the time point corresponding to the legacy data with the longest caching time to the current time point; and

a generation submodule configured to generate the recovery cycle having a time length consistent with the time length.

For example, the processing module includes:

a setting submodule configured to set multiple processing time periods sequentially according to the unit time length of the recovery cycle, and allocate to-be-processed data to each of the processing time periods based on the legacy data and the newly added data;

a processing submodule configured to process the corresponding to-be-processed data within each of the processing time periods; and

a recovery submodule configured to recover the computing task to normal processing logic after the recovery cycle ends.

For example, the processing time period is composed of data processing time and data synchronization time in sequence, and the processing submodule is configured to:

process the to-be-processed data within the data processing time, and store the to-be-processed data that has been processed after the data processing time ends; and

discard the to-be-processed data that has not been processed within the data synchronization time if the to-be-processed data that has not been processed exists after the data processing time ends.

As shown from the technical solution of the present disclosure, the processing node acquires a time point of current legacy data with the longest caching time in a distributed message queue after a restart of the processing node has completed, determines a recovery cycle according to a current time point and the time point of the legacy data, and processes the legacy data and newly added data in the distributed message queue within the recovery cycle. Thus, an interruption of data processing resulting from a restart may be avoided, an impact on the user's feeling may be eliminated, and user experience is improved.

### BRIEF DESCRIPTION OF THE DRAWINGS

To describe the technical solutions in the example embodiments of the present disclosure more clearly, the following briefly introduces the accompanying drawings required for describing the example embodiments. Apparently, the accompanying drawings in the following description merely represent some example embodiments of the present disclosure, and those of ordinary skill in the art may still derive other drawings from these accompanying drawings without creative efforts.

FIG. 1 is a schematic architectural diagram of a real-time monitoring service of a cloud platform in the conventional techniques;

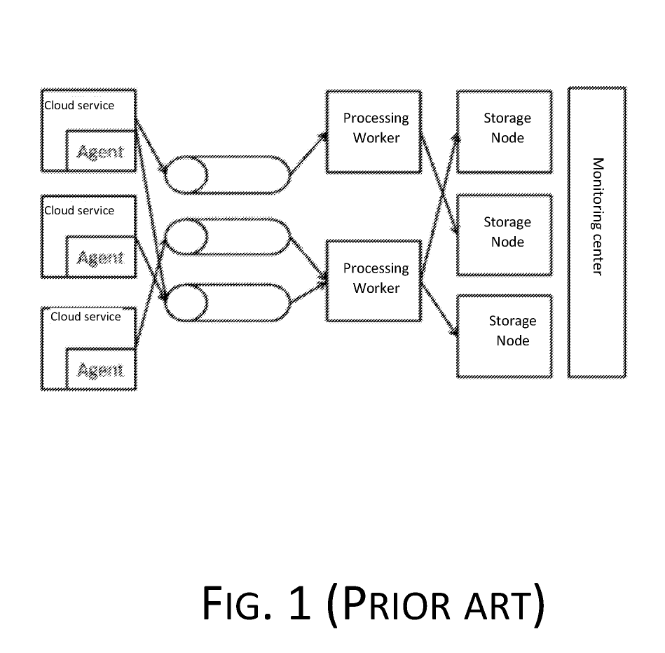

FIG. 2 is a flowchart of a method for processing data after a restart of a node according to the present disclosure;

FIG. 3 is a schematic diagram of processing data within a recovery cycle according to a specific example embodiment of the present disclosure; and

FIG. 4 is a schematic structural diagram of a data processing device according to the present disclosure.

### DETAILED DESCRIPTION

In view of the problems in the conventional techniques, the present disclosure provides a method for processing data after a restart of a node. The method is applied to a data processing system that includes a distributed message queue and a processing node, to avoid the problem that the user's feeling is affected by an interruption of data processing caused when the processing node in the data processing system is restarted for some reason. It should be noted that the data processing system may be a real-time monitoring system in the conventional techniques or a user log recording system. On this basis, those skilled in the art may also apply the solution of the present disclosure to other systems that have a real-time processing requirement on data, and such applications shall also belong to the protection scope of the present disclosure.

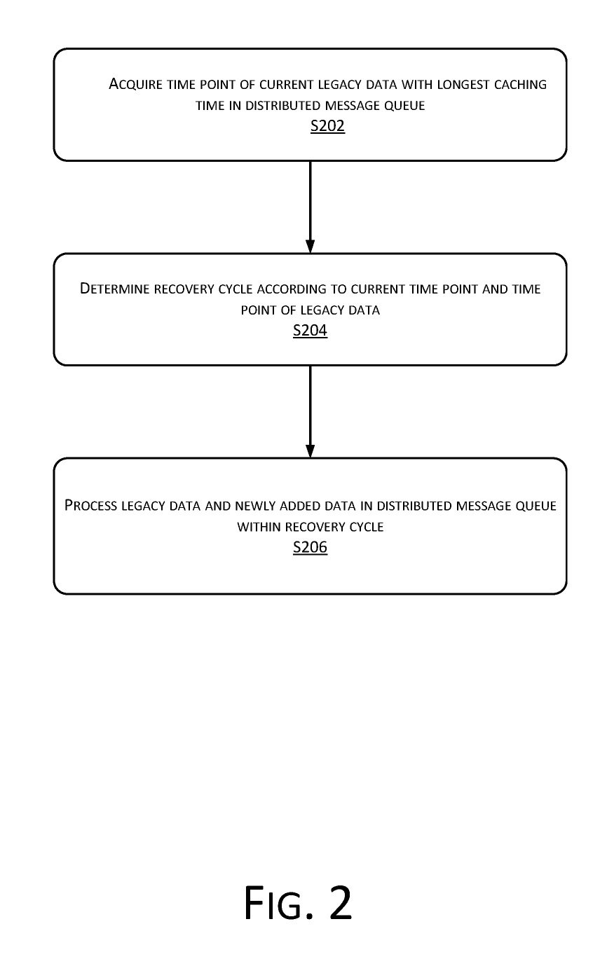

As shown in FIG. 2, the method includes the following steps.

S202. The processing node acquires a time point of current legacy data with the longest caching time in the distributed message queue after a restart of the processing node has completed.

In a current data processing system for processing data in real time, a processing node often needs to be restarted because of the device itself or human causes. As a processing node is usually a single data processing device or a logical sum of multiple data processing devices, the processing node often cannot timely take data from the distributed message queue connected therewith during the restart, which causes the legacy of to-be-processed data in the message queue. Therefore, when the restart of the processing node is completed, how much time the restart process takes may be determined by comparing the time point of the earliest data in the message queue with the current time point. It should be noted here that the time point of the legacy data with the longest caching time in this step may be set to the time point at which the cached data is generated, or may be set to the time point at which the processing node should acquire the cached data. Setting different time points for different situations on the premise that the processing node may determine the restart duration belongs to the protection scope of the present disclosure.

In addition, there is often a period of time from the processing node's stopping acquiring the data from the message queue to formal restart, during which the processing node itself still caches some data that has been acquired from the message queue previously. Thus, in order to ensure that the processing node may automatically save the data cached in the processing node without loss in the case of timeout while closing the data receiving function, in an example embodiment of the present disclosure, after receiving an instruction of closing a computing task (the instruction may be sent automatically by the system according to the state of the processing node or sent manually), the processing node, on one hand, stops receiving data from the distributed message queue, and on the other hand, writes data currently cached in the processing node into the storage node in the current data processing system upon completion of the processing of the data, to achieve automatic saving of the cached data.

In a specific example embodiment of the present disclosure, first, a close instruction is sent to a real-time computing task of the processing node through the system. The computing task enters a closed state after receiving the instruction, and stops receiving the message from the message queue. The processing node continues to process the cached data, then waits for timeout of a computing result and automatically writes the data into a storage service. Real-time computing means processing in a situation where there is no new data for a period of time, and a mechanism of automatically saving a computing result when a time window is exceeded will exist. Therefore, the processed data may be persistent through this step, which thus does not require saving and recovery of the intermediate state.

S204. The processing node determines a recovery cycle according to a current time point and the time point of the legacy data.

Based on the time point of the legacy data in S202, in an example embodiment of the present disclosure, a time length from the time point corresponding to the legacy data with the longest caching time to the current time point is acquired, and the recovery cycle having a time length consistent with the time length is generated.

For example, after the task of the processing node is restarted, the processing node will compare a difference between the data time in the message queue and the system time, and set a data recovery cycle. For example, if the data time is 12:02:10 and the current time is 12:04:08, it indicates that it takes about 2 minutes to close the task and initialize the task during start, and data processing in the two minutes needs to be caught up. A recovery cycle of, e.g., 2 minutes, may be set after the data size and the processing capability are balanced. The time consumed by turning off and starting the task and the time for catching up data should be within 5 minutes;

otherwise, the data delay will exceed 5 minutes.

S206. The processing node processes the legacy data and newly added data in the distributed message queue within the recovery cycle.

After the recovery cycle is determined, the processing node needs to process two batches of data at the same time within the cycle subsequently. One is the legacy data in the message queue, and the other is newly added data in the message queue within the cycle. In order to processing the two batches of data in an orderly manner, in an example embodiment of the present disclosure, multiple processing time periods may be sequentially set according to the unit time length of the recovery cycle first, and then to-be-processed data is allocated to each of the processing time periods based on the legacy data and the newly added data. In this process, the legacy data and the newly added data may be mixed together to be evenly distributed to the processing time periods, or may be allocated separately for different processing time periods according to categories. Both the two implementations belong to the protection scope of the present disclosure.

After the corresponding to-be-processed data is allocated to each of the processing time periods, in this example embodiment, the corresponding to-be-processed data may be processed within each of the processing time periods, and the computing task may be recovered to normal processing logic after the recovery cycle ends. Thus, seamless connection of data processing after the processing node is restarted is completed.

Further, in order to enable the processing node to efficiently complete data processing within each processing time period, in an example embodiment of the present disclosure, the processing time periods are divided into data processing time and data synchronization time, and the two are formed in sequence (data processing time−data synchronization time). When the corresponding to-be-processed data is processed within each of the processing time periods, the to-be-processed data is processed within the data processing time first, and the to-be-processed data that has been processed is stored after the data processing time ends. Then, the to-be-processed data that has not been processed is discarded within the data synchronization time if the to-be-processed data that has not been processed exists after the data processing time ends.

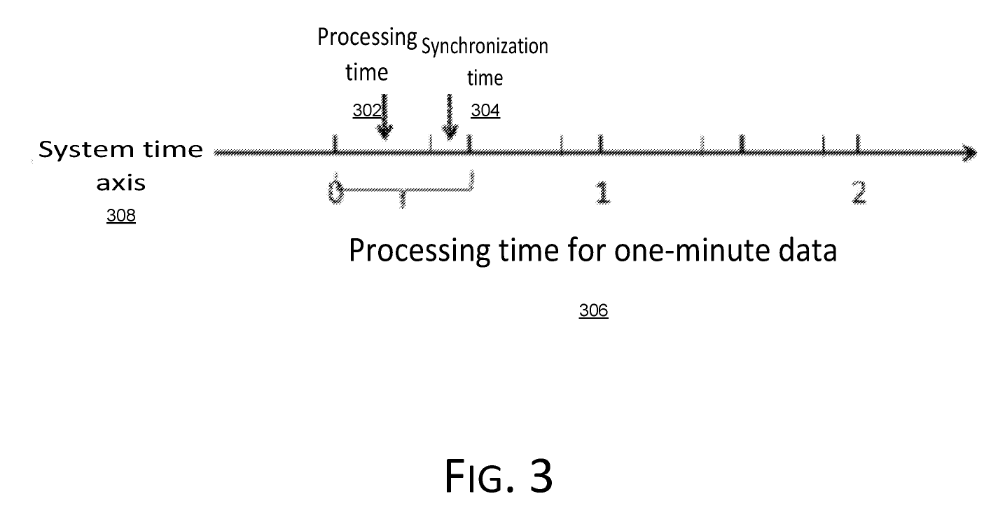

By using the data in the specific example embodiment in S204 and the schematic diagram of data processing shown in FIG. 3 as an example, in this step, the processing node needs to catch up 4-minute data within 2 minutes. Therefore, in the specific example embodiment, 2 minutes is equally divided into four parts, and each part is then divided into data processing time 302 and synchronization time 304 according to a ratio. In FIG. 3, processing time for one-minute data 306 is shown along a system time axis 308. The data in the corresponding minute is processed within the processing time and the result is stored. Data in the current minute is quickly discarded within the synchronization time, and the processing node is synchronized to the processing in the next minute.

Based on a series of operations before and after the restart of the processing node, an impact on the user's feeling that may be caused by an interruption of data processing resulting from the node restart is avoided, and user experience is improved.

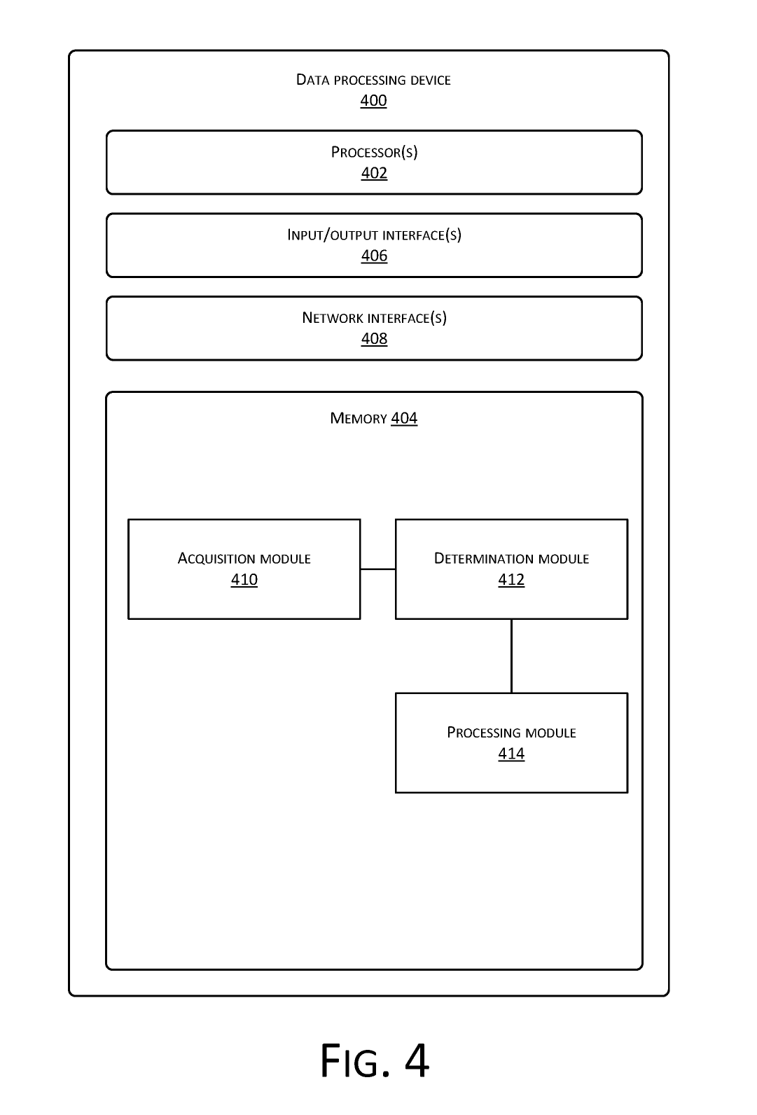

To achieve the foregoing technical objective, the present disclosure further provides a data processing device, applied as a processing node to a data processing system that includes a distributed message queue and the processing node. As shown in FIG. 4, a data processing device 400 includes one or more processor(s) 402 or data processing unit(s) and memory 404. The data processing device 400 may further include one or more input/output interface(s) 406 and one or more network interface(s) 408. The memory 404 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 404 may store therein a plurality of modules or units including:

an acquisition module 410 configured to acquire a time point of current legacy data with the longest caching time in the distributed message queue after a restart has completed;

a determination module 412 configured to determine a recovery cycle according to a current time point and the time point of the legacy data; and

a processing module 414 configured to process the legacy data and newly added data in the distributed message queue within the recovery cycle.

In an example embodiment, the data processing system further includes a storage node, and the data processing device further includes:

a closing module (not shown in FIG. 4) configured to receive an instruction of closing a computing task, stop receiving data from the distributed message queue, and write data currently cached in the data processing device into the storage node upon completion of the processing of the data.

In an example embodiment, the determination module 412 includes:

an acquisition submodule configured to acquire a time length from the time point corresponding to the legacy data with the longest caching time to the current time point; and

a generation submodule configured to generate the recovery cycle having a time length consistent with the time length.

In an example embodiment, the processing module 414 includes:

a setting submodule configured to set multiple processing time periods sequentially according to the unit time length of the recovery cycle, and allocate to-be-processed data to each of the processing time periods based on the legacy data and the newly added data;

a processing submodule configured to process the corresponding to-be-processed data within each of the processing time periods; and

a recovery submodule configured to recover the computing task to normal processing logic after the recovery cycle ends.

In an example embodiment, the processing time period is composed of data processing time and data synchronization time in sequence, and the processing submodule is configured to:

process the to-be-processed data within the data processing time, and store the to-be-processed data that has been processed after the data processing time ends; and

discard the to-be-processed data that has not been processed within the data synchronization time if the to-be-processed data that has not been processed exists after the data processing time ends.

From the descriptions of the implementations above, those skilled in the art may clearly understand that the present disclosure may be implemented by hardware, or may be implemented by software plus a necessary universal hardware platform. Based on such understanding, the technical solutions of the present disclosure may be implemented in the form of a software product. The software product may be stored in a non-volatile storage medium (which may be a CD-ROM, a USB flash disk, a removable hard disk, or the like), and includes several instructions for instructing a computer device (which may be a personal computer, a server, a network device, or the like) to perform the methods described in various implementation scenarios of the present disclosure.

Those skilled in the art may understand that the accompanying drawings are merely schematic diagrams of an example implementation scenario, and modules or procedures in the accompanying drawings are not necessarily mandatory to implement the present disclosure.

Those skilled in the art may understand that modules in an apparatus in an implementation scenario may be distributed in the apparatus in the implementation scenario according to the description of the implementation scenario, or may be correspondingly changed and located in one or more apparatuses different from that in the implementation scenario. The modules in the implementation scenario may be combined into one module, or may be further divided into a plurality of submodules.

The sequence numbers of the present disclosure are merely for the convenience of description, and do not imply the preference among the implementation scenarios.

The above merely describes several example implementation scenarios of the present disclosure, but the present disclosure is not limited thereto. Any change that those skilled in the art may conceive of shall fall within the protection scope of the present disclosure.

The present disclosure may further be understood with clauses as follows.

Clause 1. A method for processing data after a restart of a node, wherein the method is applied to a data processing system that comprises a distributed message queue and a processing node, the method comprising:

acquiring, by the processing node, a time point of legacy data currently with longest caching time in the distributed message queue after a restart of the processing node has completed;

determining, by the processing node, a recovery cycle according to a current time point and the time point of the legacy data; and

processing, by the processing node, the legacy data and newly added data in the distributed message queue within the recovery cycle.

Clause 2. The method of clause 1, wherein the data processing system further comprises a storage node, and before the restart of the processing node has completed, the method further comprises:

receiving, by the processing node, an instruction of closing a computing task; and

stopping, by the processing node, receiving data from the distributed message queue, and writing data currently cached in the processing node into the storage node upon completion of the processing of the data.

Clause 3. The method of clause 1, wherein the determining, by the processing node, the recovery cycle according to the current time point and the time point of the legacy data includes:

acquiring a time length from the time point corresponding to the legacy data with the longest caching time to the current time point; and

generating the recovery cycle having a time length consistent with the time length.

Clause 4. The method of clause 1, wherein the processing, by the processing node, the legacy data and the newly added data in the distributed message queue within the recovery cycle includes:

setting multiple processing time periods sequentially according to a unit time length of the recovery cycle, and allocating to-be-processed data to each of the processing time periods based on the legacy data and the newly added data; and

processing the corresponding to-be-processed data within each of the processing time periods, and recovering the computing task to normal processing logic after the recovery cycle ends.

Clause 5. The method of clause 4, wherein the processing time period is composed of data processing time and data synchronization time in sequence, and the processing the corresponding to-be-processed data within each of the processing time periods includes:

processing the to-be-processed data within the data processing time, and storing the to-be-processed data that has been processed after the data processing time ends; and

discarding, within the data synchronization time, the to-be-processed data that has not been processed if the to-be-processed data that has not been processed exists after the data processing time ends.

Clause 6. A data processing device, applied as a processing node to a data processing system that comprises a distributed message queue and the processing node, the data processing device comprising:

an acquisition module configured to acquire a time point of legacy data currently with longest caching time in the distributed message queue after a restart has completed;

a determination module configured to determine a recovery cycle according to a current time point and the time point of the legacy data; and

a processing module configured to process the legacy data and newly added data in the distributed message queue within the recovery cycle.

Clause 7. The data processing device of clause 6, wherein the data processing system further comprises a storage node, and the data processing device further comprises:

a closing module configured to receive an instruction of closing a computing task, stop receiving data from the distributed message queue, and write data currently cached in the data processing device into the storage node upon completion of the processing of the data.

Clause 8. The data processing device of clause 6, wherein the determination module further comprises:

an acquisition submodule configured to acquire a time length from the time point corresponding to the legacy data with the longest caching time to the current time point; and

a generation submodule configured to generate the recovery cycle having a time length consistent with the time length.

Clause 9. The data processing device of clause 6, wherein the processing module further comprises:

a setting submodule configured to set multiple processing time periods sequentially according to a unit time length of the recovery cycle, and allocate to-be-processed data to each of the processing time periods based on the legacy data and the newly added data;

a processing submodule configured to process the corresponding to-be-processed data within each of the processing time periods; and

a recovery submodule configured to recover the computing task to normal processing logic after the recovery cycle ends.

Clause 10. The data processing device of clause 9, wherein the processing time period is composed of data processing time and data synchronization time in sequence, and the processing submodule is configured to:

process the to-be-processed data within the data processing time, and store the to-be-processed data that has been processed after the data processing time ends; and

discard, within the data synchronization time, the to-be-processed data that has not been processed if the to-be-processed data that has not been processed exists after the data processing time ends.

What is claimed is:

1. A method comprising:
acquiring, by a processing node, a time point of legacy data with longest caching time in a distributed message queue after a restart of the processing node has completed;
determining, by the processing node, a recovery cycle according to a current time point and the time point of the legacy data; and
processing, by the processing node, the legacy data and newly added data in a distributed message queue within the recovery cycle.

2. The method of claim 1, wherein the method is applied to a data processing system that includes the distributed message queue and the processing node.

3. The method of claim 2, wherein the data processing system further includes a storage node.

4. The method of claim 1, further comprising:
before the restart of the processing node has completed,
receiving, by the processing node, an instruction of closing a computing task;
stopping, by the processing node, receiving data from the distributed message queue; and
writing data currently cached in the processing node into a storage node upon completion of processing of the data.

5. The method of claim 1, wherein the determining, by the processing node, the recovery cycle according to the current time point and the time point of the legacy data includes:
acquiring a time length from the time point corresponding to the legacy data with the longest caching time to the current time point; and
generating the recovery cycle having a time length consistent with the time length from the time point corresponding to the legacy data with the longest caching time to the current time point.

6. The method of claim 5, wherein the time length of the recovery cycle is same as the time length from the time point corresponding to the legacy data with the longest caching time to the current time point.

7. The method of claim 1, wherein the processing, by the processing node, the legacy data and the newly added data in the distributed message queue within the recovery cycle includes:
setting multiple processing time periods sequentially according to a unit time length of the recovery cycle; and
allocating to-be-processed data to each of the processing time periods based on the legacy data and the newly added data.

8. The method of claim 7, wherein the processing, by the processing node, the legacy data and the newly added data in the distributed message queue within the recovery cycle further includes:
processing the corresponding to-be-processed data within each of the processing time periods; and
recovering the computing task to a normal processing logic after the recovery cycle ends.

9. The method of claim 8, wherein the processing time period includes a data processing time and a data synchronization time in sequence.

10. The method of claim 9, wherein the processing the corresponding to-be-processed data within each of the processing time periods includes:
processing the to-be-processed data within the data processing time, and storing the to-be-processed data that has been processed after the data processing time ends; and
discarding, within the data synchronization time, the to-be-processed data that has not been processed in response to determining that the to-be-processed data that has not been processed exists after the data processing time ends.

11. A device comprising:
one or more processors; and
one or more memories storing thereon computer-readable instructions that, when executed by the one or more processors, cause the one or more processors to perform acts comprising:
acquiring a time point of legacy data with longest caching time in a distributed message queue after a restart of the processing node has completed;
determining a recovery cycle according to a current time point and the time point of the legacy data; and
processing the legacy data and newly added data in a distributed message queue within the recovery cycle,
wherein the device acts as processing node in a data processing system that includes the distributed message queue and the processing node.

12. The device of claim 11, wherein the data processing system further includes a storage node.

13. The device of claim 12, wherein the acts further comprise:
receiving an instruction of closing a computing task;
stopping receiving data from the distributed message queue; and
writing data currently cached in the device into the storage node upon completion of processing of the data.

14. The device of claim 11, wherein the determining the recovery cycle according to the current time point and the time point of the legacy data includes:
acquiring a time length from the time point corresponding to the legacy data with the longest caching time to the current time point; and
generating the recovery cycle having a time length consistent with the time length from the time point corresponding to the legacy data with the longest caching time to the current time point.

15. The device of claim 14, wherein the time length of the recovery cycle is same as the time length from the time point corresponding to the legacy data with the longest caching time to the current time point.

16. The device of claim 11, wherein the processing the legacy data and the newly added data in the distributed message queue within the recovery cycle includes:
setting multiple processing time periods sequentially according to a unit time length of the recovery cycle;
allocating to-be-processed data to each of the processing time periods based on the legacy data and the newly added data;
processing the corresponding to-be-processed data within each of the processing time periods; and
recovering the computing task to a normal processing logic after the recovery cycle ends.

17. The device of claim 16, wherein:
the processing time period includes a data processing time and a data synchronization time in sequence.

18. The device of claim 16, wherein the processing the corresponding to-be-processed data within each of the processing time periods includes:
processing the to-be-processed data within the data processing time, and storing the to-be-processed data that has been processed after the data processing time ends; and
discarding, within the data synchronization time, the to-be-processed data that has not been processed in response to determining that the to-be-processed data that has not been processed exists after the data processing time ends.

19. One or more memories storing thereon computer-readable instructions that, when executed by one or more processors, cause the one or more processors to perform acts comprising:
acquiring a time point of legacy data with longest caching time in a distributed message queue after a restart of the processing node has completed;
determining a recovery cycle according to a current time point and the time point of the legacy data; and
processing the legacy data and newly added data in a distributed message queue within the recovery cycle.

20. The one or more memories of claim 19, wherein the acts further comprise:
receiving an instruction of closing a computing task;
stopping receiving data from the distributed message queue; and
writing data currently cached in the processing node into a storage node upon completion of processing of the data.
